(19) United States
(12) Patent Application Publication
(10) Pub. No.: US 2011/0084959 A1
(43) Pub. Date: Apr. 14, 2011

(54) PIXEL AND ORGANIC LIGHT EMITTING DISPLAY USING THE SAME

(76) Inventor: Yang-Wan Kim, Yongin-city (KR)

(21) Appl. No.: 12/840,257

(22) Filed: Jul. 20, 2010

(30) Foreign Application Priority Data
Oct. 9, 2009 (KR) 10-2009-0096105

(51) Int. Cl. G09G 3/32; G09G 5/00; G06F 3/038

(52) U.S. Cl. 345/213; 345/211; 345/76

(57) ABSTRACT

A pixel of an organic light emitting display includes an OLED having a cathode electrode coupled to a second power source, a second transistor having a second electrode coupled to an anode electrode of the OLED, the second transistor being for supplying current to the OLED, a first transistor coupled between a data line and a gate electrode of the second transistor, the first transistor configured to turn on when a scan signal is supplied to a scan line, a third transistor coupled between a first electrode of the second transistor and a first power source, the third transistor configured to turn off when an emission control signal is supplied to an emission control line, and a storage capacitor coupled between the gate electrode and first electrode of the second transistor. The voltage of the data signal is equal to or lower than a threshold voltage of the OLED.

### CROSS-REFERENCE TO RELATED APPLICATION

This application claims priority to and the benefit of Korean Patent Application No. 10-2009-0096105, filed on Oct. 9, 2009, in the Korean Intellectual Property Office, the entire content of which is incorporated herein by reference.

### BACKGROUND

1. Field

An aspect of an embodiment of the present invention relates to a pixel and an organic light emitting display using the same.

2. Description of the Related Art

Various flat panel displays (FPDs) with reduced weight and volume in comparison to cathode ray tubes (CRTs) have been developed. The FPDs include liquid crystal displays (LCDs), field emission displays (FEDs), plasma display panels (PDPs), and organic light emitting displays.

The organic light emitting displays display images using organic light emitting diodes (OLEDs) that generate light by re-combination of electrons and holes. The organic light emitting display has fast response speed and is driven with low power consumption.

FIG. 1 is a circuit diagram illustrating a pixel of a conventional organic light emitting display.

Referring to FIG. 1, a pixel 4 of the conventional organic light emitting display includes an OLED and a pixel circuit 2 coupled to a data line Dm and a scan line Sn to control the OLED.

The anode electrode of the OLED is coupled to the pixel circuit 2, and the cathode electrode of the OLED is coupled to a second power source ELVSS. The OLED emits light with a brightness corresponding to the current supplied from the pixel circuit 2.

The pixel circuit 2 controls the amount of current supplied to the OLED to correspond to a data signal supplied to the data line Dm when a scan signal is supplied to the scan line Sn. Therefore, the pixel circuit 2 includes a second transistor M2 coupled between a first power source ELVDD and the OLED, a first transistor M1 coupled among the second transistor M2, the data line Dm, and the scan line Sn, and a storage capacitor Cst coupled between the gate electrode and the first electrode of the second transistor M2.

The gate electrode of the first transistor M1 is coupled to the scan line Sn, and the first electrode of the first transistor M1 is coupled to the data line Dm. The second electrode of the first transistor M1 is coupled to one terminal of the storage capacitor Cst. Here, the first electrode is a source electrode or a drain electrode, and the second electrode is an electrode different from the first electrode. For example, when the first electrode is the source electrode, the second electrode is the drain electrode. The first transistor M1 coupled to the scan line Sn and the data line Dm is turned on to supply the data signal supplied from the data line Dm to the storage capacitor Cst when the scan signal is supplied from the scan line Sn. Here, the storage capacitor Cst is charged with a voltage corresponding to the data signal.

The gate electrode of the second transistor M2 is coupled to one end of the storage capacitor Cst, and the first electrode of the second transistor M2 is coupled to the other terminal of the storage capacitor Cst and the first power source ELVDD. The second electrode of the second transistor M2 is coupled to the anode electrode of the OLED. The second transistor M2 controls the amount of current that flows from the first power source ELVDD to the second power source ELVSS via the OLED to correspond to the value of the voltage stored in the storage capacitor Cst. Here, the OLED emits light with a brightness corresponding to the amount of current supplied from the second transistor M2.

However, the conventional organic light emitting display may not display an image with desired brightness due to a change in efficiency in accordance with the deterioration of the OLED. As time passes, the OLED deteriorates, therefore the brightness of the light generated by the OLED to correspond to the same data signal becomes gradually lower.

In addition, in the conventional organic light emitting display, the value of the voltage of the first power source ELVDD varies (e.g., voltage reduction) in accordance with the position of the pixel 2 so that an image with desired brightness may not be displayed.

### SUMMARY

An aspect of an embodiment of the present invention relates to a pixel capable of displaying an image with desired brightness regardless of the deterioration of an organic light emitting diode (OLED) and the voltage reduction of a first power source and an organic light emitting display using the same.

According to an embodiment of the present invention, there is provided an organic light emitting display, including a scan driver for sequentially supplying scan signals to scan lines and for sequentially supplying emission control signals to emission control lines extending in parallel with the scan lines, a data driver for supplying data signals to data lines in synchronization with the scan signals, and a plurality of pixels at crossing regions of the scan lines and the data lines. Each of the pixels includes an organic light emitting diode (OLED) having a cathode electrode coupled to a second power source, a second transistor having a second electrode coupled to an anode electrode of the OLED, the second transistor being for supplying current to the OLED, a first transistor coupled between a corresponding one of the data lines and a gate electrode of the second transistor, the first transistor being configured to turn on when a scan signal is supplied to a corresponding one of the scan lines, a third transistor coupled between a first electrode of the second transistor and a first power source, the third transistor being configured to turn off when an emission control signal is supplied to a corresponding one of the emission control lines, and a storage capacitor coupled between the gate electrode of the second transistor and the first electrode of the second transistor. The voltage of the data signal is equal to or lower than a threshold voltage of the OLED.

The first power source is configured to output a voltage higher than the threshold voltage of the OLED. The scan driver is configured to supply the emission control signal to an i-th emission control line of the emission control lines to overlap with the scan signal supplied to an i-th (i is a natural number) scan line of the scan lines. The scan driver is configured to supply the emission control signal to the i-th emission control line earlier than the scan signal supplied to the i-th scan line and to stop the supply of the emission control signal to the i-th emission control line after the supply of the scan signal to the i-th scan line is stopped. The data signal is set to have a voltage at which the second transistor may be completely turned on. The data signal is set to have a voltage lower than a voltage of the second power source.

According to another embodiment of the present invention, there is provided a pixel, including an organic light emitting diode (OLED), a second transistor having a first electrode and a second electrode coupled to an anode electrode of the OLED, the second transistor being for controlling an amount of current supplied to the OLED, a first transistor configured to turn on to supply a data signal to a gate electrode of the second transistor when a scan signal is supplied to a gate electrode of the first transistor, a third transistor coupled between the second electrode of the second transistor and a first power source, the third transistor configured to continuously turn off in a period where the first transistor is turned on, and a storage capacitor coupled between the gate electrode of the second transistor and the first electrode of the second transistor. The voltage of the data signal is equal to or lower than a threshold voltage of the OLED.

According to another embodiment of the present invention, a pixel includes: an organic light emitting diode (OLED); a driving transistor for driving the OLED, the driving transistor having a first electrode and a second electrode coupled to an anode electrode of the OLED; an emission control transistor coupled between a power source and the first electrode of the driving transistor, the emission control transistor configured to continuously turn off when a data signal is supplied to a gate electrode of the driving transistor; and a storage capacitor coupled between the gate electrode of the driving transistor and the first electrode of the driving transistor. A voltage of the data signal is equal to or lower than a threshold voltage of the OLED.

In the pixel and the organic light emitting display according to the embodiments of the present invention, as the OLED deteriorates, the amount of current supplied to the OLED is increased so that the deterioration of the OLED may be compensated for. In addition, according to the present invention, since the current supplied to the OLED is determined regardless of the first power source, an image with desired brightness may be displayed regardless of the voltage reduction of the first power source.

### BRIEF DESCRIPTION OF THE DRAWINGS

The accompanying drawings, together with the specification, illustrate exemplary embodiments of the present invention, and, together with the description, serve to explain the principles of the present invention.

FIG. 1 is a circuit diagram illustrating a pixel of a conventional organic light emitting display;

FIG. 2 is a circuit diagram illustrating an organic light emitting display according to an embodiment of the present invention;

FIG. 3 is a circuit diagram illustrating an embodiment of the pixel of FIG. 2;

FIG. 4 is a timing diagram for illustrating a method of driving the pixel of FIG. 3; and

FIG. 5 is a graph illustrating a current error rate in accordance with the voltage reduction of a first power source in the pixel of FIG. 3.

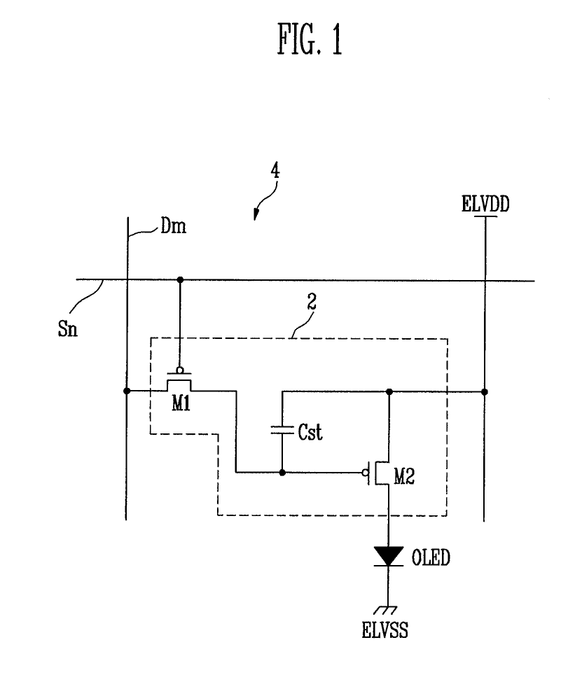

### DETAILED DESCRIPTION

Hereinafter, certain exemplary embodiments according to the present invention will be described with reference to the accompanying drawings. Here, when a first element is described as being coupled to a second element, the first element may be directly coupled to the second element, or it may be indirectly coupled to the second element via a third element. Further, some of the elements that are not essential to the complete understanding of the invention are omitted for clarity. Also, like reference numerals refer to like elements throughout.

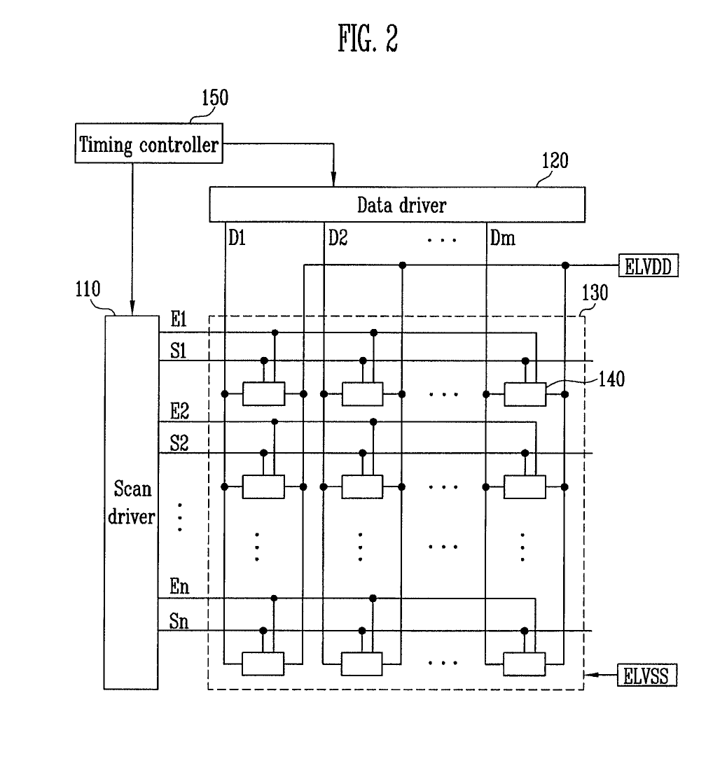

Hereinafter, exemplary embodiments of the present invention will be described in detail with reference to FIGS. 2 to 5.

FIG. 2 is a circuit diagram illustrating an organic light emitting display according to an embodiment of the present invention.

Referring to FIG. 2, the organic light emitting display according to an embodiment of the present invention includes a display unit 130 including pixels 140 positioned at crossing regions of scan lines S1 to Sn and data lines D1 to Dm, a scan driver 110 for driving the scan lines S1 to Sn and emission control lines E1 to En, a data driver 120 for driving the data lines D1 to Dm, and a timing controller 150 for controlling the scan driver 110 and the data driver 120.

The scan driver 110 generates scan signals by the control of the timing controller 150 and sequentially supplies the generated scan signals to the scan lines S1 to Sn. In addition, the scan driver 110 generates emission control signals and sequentially supplies the generated emission control signals to the emission control lines E1 to En. Here, the emission control signal supplied to the i-th (i is a natural number) emission control line Ei is supplied to overlap the scan signal supplied to the i-th scan line Si. In one embodiment, the emission control signal supplied to the i-th emission control line Ei is supplied earlier than the scan signal supplied to the i-th scan line Si, and the supply of the emission control signal is stopped after the supply of the scan signal to the i-th scan line Si is stopped.

On the other hand, the scan signal is set to have a voltage (for example, a low level voltage) at which a transistor may be turned on, and the emission control signal is set to have a voltage (for example, a high level voltage) at which a transistor may be turned off.

The data driver 120 generates data signals by the control of the timing controller 150 and supplies the generated data signals to the data lines D1 to Dm in synchronization with the scan signals.

The timing controller 150 controls the scan driver 110 and the data driver 120. In addition, the timing controller 150 transmits the data supplied from the outside to the data driver 120.

The display unit 130 receives power from a first power source ELVDD and a second power source ELVSS from the outside, and the first power source ELVDD and the second power source ELVSS supply power to the pixels 140 to generate light corresponding to the data signals.

Each of the pixels 140 compensates for the deterioration of the OLED included therein so that light with desired brightness is generated. That is, the pixels 140 increase the amount of current supplied to the OLEDs as the OLEDs deteriorate to compensate for the deterioration of the OLEDs. In addition, each of the pixels 140 controls the amount of current that flows to the OLED regardless of the voltage reduction of the first power source ELVDD.

According to an embodiment of the present invention, the voltages of the data signals are set so that the driving transistors included in the pixels 140 are fully turned on. As an example, the voltages of the data signals are set to be equal to or lower than the threshold voltage of the OLEDs included in the pixels 140. The first power source ELVDD is set to have a voltage higher than the threshold voltages of the OLEDs. In one embodiment, the voltage of the first power source ELVDD, the voltage of the data signal, and the threshold voltage of the OLED are set as illustrated in EQUATION 1.

ELVDD>Voled≧data Equation 1

wherein, Vdata represents the voltage of the data signal, and Voled represents the threshold voltage of the OLED. The voltage of the second power source ELVSS that is not included in EQUATION 1 is experimentally determined so that current may stably flow to the OLED. For example, the voltage of the second power source ELVSS may be set as a voltage higher than the voltage Vdata of the data signal.

FIG. 3 is a circuit diagram illustrating an embodiment of the pixel of FIG. 2. For the sake of convenience, the pixel 140 coupled to the m-th data line Dm and the n-th scan line Sn will be illustrated.

Referring to FIG. 3, the pixel 140 according to an embodiment of the present invention includes an OLED and a pixel circuit 142 for supplying current to the OLED.

The anode electrode of the OLED is coupled to the pixel circuit 142, and the cathode electrode of the OLED is coupled to the second power source ELVSS. The OLED generates light with a brightness corresponding to the current supplied from the pixel circuit 142.

The pixel circuit 142 receives the data signal supplied to the data line Dm when a scan signal is supplied to the scan line Sn. In addition, the pixel circuit 142 is charged with a voltage corresponding to the data signal, the threshold voltage of the OLED, and the first power source ELVDD and supplies a current corresponding to the charged voltage to the OLED. In one embodiment, the pixel circuit 142 includes three transistors M1 to M3 and one capacitor Cst.

The gate electrode of the first transistor M1 is coupled to the scan line Sn, and the first electrode of the first transistor M1 is coupled to the data line Dm. The second electrode of the first transistor M1 is coupled to a first node N1 that is coupled to the gate electrode of the second transistor M2. The first transistor M1 is turned on when the scan signal is supplied to the scan line Sn.

The gate electrode of the second transistor M2 is coupled to the first node N1, and the first electrode of the second transistor M2 is coupled to a second node N2 that is coupled to the second electrode of the third transistor M3. The second electrode of the second transistor M2 is coupled to the anode electrode of the OLED. The second transistor M2 supplies the current corresponding to the voltage stored in the storage capacitor Cst to the OLED.

The gate electrode of the third transistor M3 is coupled to the emission control line En, and the first electrode of the third transistor M3 is coupled to the first power source ELVDD. The second electrode of the third transistor M3 is coupled to the second node N2. The third transistor M3 is turned off when an emission control signal is supplied to the emission control line En and is turned on in the other period. Here, since the emission control signal is supplied to the emission control line En to overlap with the scan signal supplied to the scan line Sn, the third transistor M3 is continuously turned off in a period where the first transistor M1 is turned on.

The storage capacitor Cst is coupled between the first node N1 and the second node N2. The storage capacitor Cst is charged with a voltage corresponding to the data signal, the threshold voltage of the OLED, and the first power source ELVDD.

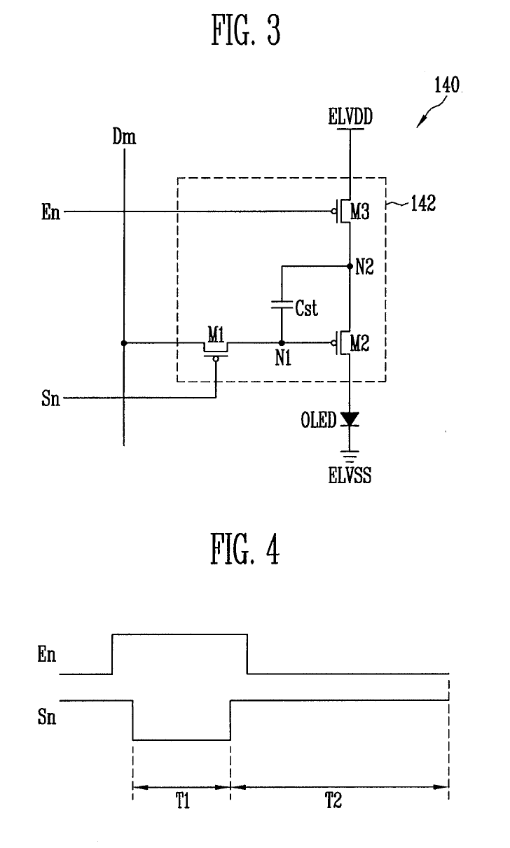

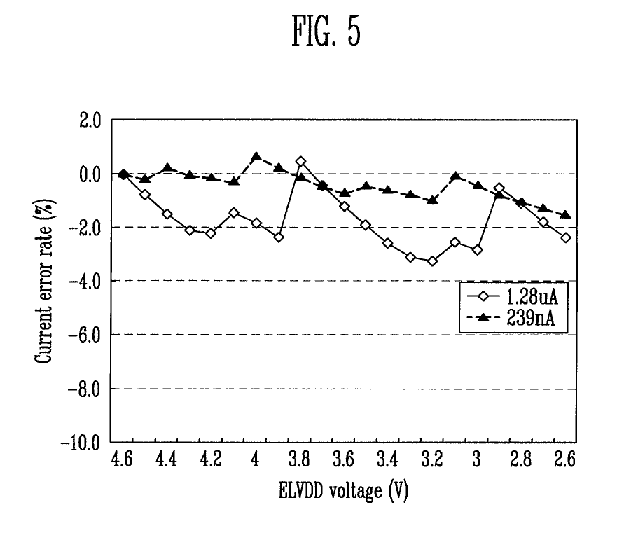

FIG. 4 is a graph for illustrating a method of driving the pixel of FIG. 3.

Exemplary operation processes will be described in detail with reference to FIGS. 3 and 4. First, in a first period T1, the emission control signal is supplied to the emission control line En, and the scan signal is supplied to the scan line Sn.

When the emission control signal is supplied to the emission control line En, the third transistor M3 is turned off. When the scan signal is supplied to the scan line Sn, the first transistor M1 is turned on. When the first transistor M1 is turned on, the data signal is supplied from the data line Dm to the first node N1 via the first transistor M1.

When the data signal is supplied to the first node N1, the second transistor M2 is turned on in accordance with the data signal. When the second transistor M2 is turned on, the threshold voltage Voled of the OLED is supplied to the second node N2. That is, in the first period T1, the first node N1 is set to have the voltage Vdata of the data signal, and the second node N2 is set to have the threshold voltage Voled of the OLED.

In a second period T2, the supply of the scan signal to the scan line Sn is stopped, and the supply of the emission control signal to the emission control line En is stopped.

When the supply of the scan signal to the scan line Sn is stopped, the first transistor M1 is turned off. In this case, the first node N1 is floated. When the supply of the emission control signal to the emission control line En is stopped, the third transistor M3 is turned on.

When the third transistor M3 is turned on, the voltage of the second node N2 increases from the threshold voltage Voled of the OLED to the voltage of the first power source ELVDD. Here, the voltage of the first node N1 increases to correspond to the amount of the increase in the voltage of the second node N2. That is, in the second period T2, the second node N2 is set to have the voltage of the first power source ELVDD, and the first node N1 is set to have the voltage defined by EQUATION 2.

V_{N1}=ELVDD−Voled+Vdata Equation 2

The second transistor M2 supplies the current corresponding to the voltage applied to the first node N1 to the OLED. Here, the current supplied to the OLED is set as illustrated in EQUATION 3.

I_oled=K/2{(ELVDD−(ELVDD−Voled+Vdata)−Vth)²=K/2(Voled−Vdata−Vth)² Equation 3

wherein, I_oled represents current that flows to the OLED, and K represents a constant.

Referring to EQUATION 2, the current that flows to the OLED is determined regardless of the voltage of the first power source ELVDD. That is, according to the above-described embodiment of the present invention, an image with desired brightness may be displayed regardless of the voltage reduction of the first power source ELVDD.

In addition, the current that flows to the OLED increases as the threshold voltage Voled of the OLED increases. Here, the threshold voltage Voted of the OLED increases as the OLED deteriorates. That is, according to the above-described embodiment of the present invention, the amount of current that flows to the OLED increases as the OLED deteriorates so that the deterioration of the OLED may be compensated for.

FIG. 5 is a diagram illustrating a simulated current error rate in accordance with the voltage reduction of the first power source. In FIG. 5, for the sake of convenience, the current error rates when current of 1.28 μA and current of 239 nA flow while the voltage of the first power source ELVDD is reduced from 4.6V to 2.6V are illustrated.

Referring to FIG. 5, when the pixel 140 according to the above-described embodiment of the present invention is applied, desired current may not be correctly supplied to correspond to the voltage reduction of the first power source ELVDD. Actually, a partial change in current is generated due to the influence of the parasitic capacitor formed in the second transistor M2. However, the pixel 140 according to the above-described embodiment of the present invention effectively compensates for the voltage reduction of the first power source ELVDD so that only a current error of about 3.3% is maximally generated while the voltage of the first power source ELVDD is reduced from 4.6V to 2.6V. That is, the pixel 140 according to the above-described embodiment of the present invention effectively compensates for the voltage reduction of the first power source ELVDD so that an image with desired brightness may be displayed.

While the present invention has been described in connection with certain exemplary embodiments, it is to be understood that the invention is not limited to the disclosed embodiments, but, on the contrary, is intended to cover various modifications and equivalent arrangements included within the spirit and scope of the appended claims, and equivalents thereof.

What is claimed is:

1. An organic light emitting display comprising:
a scan driver for sequentially supplying scan signals to scan lines and for sequentially supplying emission control signals to emission control lines extending in parallel with the scan lines;
a data driver for supplying data signals to data lines in synchronization with the scan signals; and
a plurality of pixels at crossing regions of the scan lines and the data lines,
wherein each of the pixels comprises:
an organic light emitting diode (OLED) having a cathode electrode coupled to a second power source;
a second transistor having a second electrode coupled to an anode electrode of the OLED, the second transistor being for supplying current to the OLED;
a first transistor coupled between a corresponding one of the data lines and a gate electrode of the second transistor, the first transistor being configured to turn on when a scan signal is supplied to a corresponding one of the scan lines;
a third transistor coupled between a first electrode of the second transistor and a first power source, the third transistor being configured to turn off when an emission control signal is supplied to a corresponding one of the emission control lines; and
a storage capacitor coupled between the gate electrode of the second transistor and the first electrode of the second transistor,
wherein a voltage of the data signal is equal to or lower than a threshold voltage of the OLED.

2. The organic light emitting display as claimed in claim 1, wherein the first power source is configured to output a voltage higher than the threshold voltage of the OLED.

3. The organic light emitting display as claimed in claim 1, wherein the scan driver is configured to supply the emission control signal to an i-th emission control line of the emission control lines to overlap with the scan signal supplied to an i-th scan line of the scan lines.

4. The organic light emitting display as claimed in claim 1, wherein the scan driver is configured to supply the emission control signal to an i-th emission control line of the emission control lines earlier than the scan signal supplied to an i-th scan line of the scan lines and to stop the supply of the emission control signal to the i-th emission control line after the supply of the scan signal to the i-th scan line is stopped.

5. The organic light emitting display as claimed in claim 1, wherein the data signals have a voltage at which the second transistor is completely turned on.

6. The organic light emitting display as claimed in claim 1, wherein the data signals have a voltage that is lower than a voltage of the second power source.

7. A pixel comprising:
an organic light emitting diode (OLED);
a second transistor having a first electrode and a second electrode coupled to an anode electrode of the OLED, the second transistor being for controlling an amount of current supplied to the OLED;
a first transistor configured to turn on to supply a data signal to a gate electrode of the second transistor when a scan signal is supplied to a gate electrode of the first transistor;
a third transistor coupled between the second electrode of the second transistor and a first power source, the third transistor configured to continuously turn off in a period where the first transistor is turned on; and
a storage capacitor coupled between the gate electrode of the second transistor and the first electrode of the second transistor,
wherein a voltage of the data signal is equal to or lower than a threshold voltage of the OLED.

8. A pixel comprising:
an organic light emitting diode (OLED);
a driving transistor for driving the OLED, the driving transistor having a first electrode and a second electrode coupled to an anode electrode of the OLED;
an emission control transistor coupled between a power source and the first electrode of the driving transistor, the emission control transistor configured to continuously turn off when a data signal is supplied to a gate electrode of the driving transistor; and
a storage capacitor coupled between the gate electrode of the driving transistor and the first electrode of the driving transistor,
wherein a voltage of the data signal is equal to or lower than a threshold voltage of the OLED.

9. The pixel claimed in claim 8, wherein the pixel is configured to operate in a condition of ELVDD>Voled≧data, wherein ELVDD is a voltage of the power source, Voled is the threshold voltage of the OLED, and Vdata is the voltage of the data signal.
